(19) United States
(12) Patent Application Publication
(10) Pub. No.: US 2016/0271874 A1
(43) Pub. Date: Sep. 22, 2016

(54) 3D PRINTERS HAVING PLASMA APPLICATORS AND METHODS OF USING SAME

(71) Applicant: EP Technologies LLC, Akron, OH (US)

(72) Inventors: Tsung-Chan Tsai, Cuyahoga Falls, OH (US); Jeffrey S. Louis, Akron, OH (US); Sameer Kalghatgi, Copley, OH (US); Daphne Pappas Antonakas, Hudson, OH (US); Robert L. Gray, Kent, OH (US); Shirley Zhu, Cleveland Heights, OH (US); Kirill Gutsol, Cuyahoga Falls, OH (US); XinPei Lu, Akron, OH (US)

(21) Appl. No.: 15/075,591

(22) Filed: Mar. 21, 2016

Related U.S. Application Data
(60) Provisional application No. 62/135,826, filed on Mar. 20, 2015.

(51) Int. Cl. B29C 67/00

(52) U.S. Cl. CPC B29C 67/0059; B29C 67/0066; B33Y 10/00

(57) ABSTRACT

Systems and methods for printing a three-dimensional object include a 3D printing device and a plasma applicator. In some embodiments the plasma applicator is rotatably connected to the 3D printing device and may apply plasma to a molten layer of 3D printing material immediately after the material is laid, or to a solidified layer immediately before the next layer is laid. In some embodiments a second plasma applicator is included for application of plasma both before and after each layer. In some embodiments plasma is applied to the final layer of a finished 3D printed object.

### CROSS-REFERENCE TO RELATED APPLICATIONS

This application claims priority to U.S. provisional application Ser. No. 62/135,826, filed Mar. 20, 2015 (Atty. Docket No. 35416/04024) and titled 3D PRINTERS HAVING PLASMA APPLICATORS AND METHODS OF USING SAME. This application is incorporated herein by reference in its entirety.

### TECHNICAL FIELD

The present invention relates generally to a system and method for 3-dimensional (3D) printing or additive manufacturing, and more particularly, to a system and method for using plasma to improve interlayer adhesion, strength, and/or reduce porosity and/or to improve waterproofing (hydrophobic), and/or scratch-resistant properties, and/or biocompatibility of 3D printed parts.

### BACKGROUND OF THE INVENTION

3D printing is a fast emerging technology whereby three-dimensional objects are created by processor-controlled successive layering of material. As an emerging technology, 3D printed objects suffer from many drawbacks. One drawback is that 3D printed objects tend to be relatively weaker than machined, molded or fabricated objects. Polymer materials that are susceptible to UV light are often used that can lead to material degradation and poor stability. 3D printed objects often fail due to lack of adhesion between the layers of a 3D-printed material. Incomplete adhesion can cause the 3D product to warp or split. In addition, many 3D printed parts are porous and therefore cannot be used for applications that require containing a liquid, withstanding high pressure or maintaining a vacuum.

### SUMMARY

Exemplary embodiments of a system and method for printing a three-dimensional object are disclosed herein. In some exemplary embodiments, a system includes a 3D printing device and a plasma applicator. In some embodiments the plasma applicator is connected to the 3D printing device and may apply plasma to a molten layer of 3D printing material immediately after the material is laid, or to a solidified layer immediately before the next layer is laid. In some embodiments a second plasma applicator is included for application of plasma both before and after each layer. In some embodiments the plasma applicator is a separate component which applies plasma to the printed material before or after each layer. In some embodiments plasma is applied to the final layer or the outermost layer of a finished 3D printed object.

### BRIEF DESCRIPTION OF THE DRAWINGS

These and other features and advantages of the present invention will become better understood with regard to the following description and accompanying drawings in which:

FIGS. 1A and 1B are schematic diagrams of an exemplary embodiment of a 3D printing apparatus with an integrated plasma applicator for applying plasma exposure prior to adding a second layer of printed material;

FIGS. 2A and 2B are schematic diagrams of an exemplary embodiment of a 3D printing apparatus with an integrated plasma applicator for applying plasma exposure to a layer of printed material;

FIGS. 3A and 3B are schematic diagrams of an exemplary embodiment of a 3D printing apparatus with integrated plasma applicators for applying plasma before and after printing a new layer of material;

FIG. 3C is a partial cross-section of an exemplary 3D printer head with an exemplary embodiment of plasma applicator secured thereto;

FIG. 3D is a view looking up at the bottom of the exemplary embodiment of the plasma applicator of FIG. 3C;

FIG. 3E is a view looking up at a portion of a bottom of an exemplary embodiment of a plasma applicator that may be used for vapor deposition coating;

FIG. 3F is a partial cross-section of the exemplary embodiment of the plasma applicator of FIG. 3E

FIG. 3G is a partial cross-section of an exemplary embodiment of an 3D printer head and plasma applicator;

FIG. 3H is a partial cross-section of an exemplary embodiment of an 3D printer head and plasma applicator;

FIG. 3I is a partial cross-section of an exemplary embodiment of an 3D printer head and plasma applicator for vapor deposition;

FIG. 4 is a schematic diagram of an exemplary embodiment of a 3D printing apparatus with a separated plasma applicator for applying plasma prior to adding a second layer of printed material or after a new layer of material has been printed;

FIG. 5 is a schematic diagram of another exemplary embodiment of a 3D printing apparatus with a separated plasma applicator for applying plasma and/or for providing a vapor deposition coating to the final layer or the outermost layer of a finished 3D printed material; and

FIG. 6 is a schematic diagram of another exemplary embodiment of a 3D printing apparatus with plasma applicator for applying plasma and or for providing a plasma enhanced chemical vapor deposition coating prior to adding a second layer of printed material or after a new layer of material has been printed.

### DETAILED DESCRIPTION

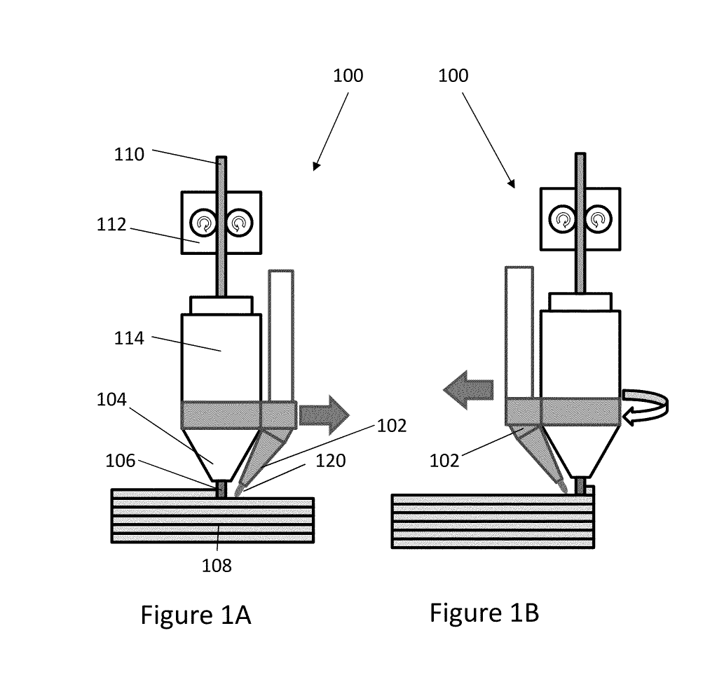

The embodiments described herein are exemplary in nature and not meant to limit the claimed invention. The plasma devices, power sources, plasma temperatures, gas temperatures, and the like described with respect to one embodiment are applicable to and may be used with or in other embodiments, and are thus, not limited to the particular detailed embodiments in which they are described. FIGS. 1A and 1B illustrate an exemplary embodiment of a 3D printing device 100 utilizing a plasma applicator 102. Treating 3D printed material with plasma can have several beneficial effects. Depending on the type of plasma used and the timing of its application, the plasma treatment can strengthen the 3D printed material, increase adhesion between layers and/or decrease the porosity of the printed objects.

The exemplary 3D printing devices shown herein are a fused deposition modeling (FDM) device, however, the exemplary plasma applicators described herein can be easily adapted to work with any number of 3D printing methods including, but not limited to, stereolithograhpy (SLA), selective laser sintering (SLS), multijet printing, colorjet printing or photopolymer jetting machine.

The 3D printing device 100 includes a nozzle portion 104 where a molten material 106 is deposited first onto a printing surface or a bed (not shown), and subsequently onto previously-deposited material 108 where it solidifies to form layers of material that form a 3D object. The printed materials, or molten materials described herein are materials that have thermoplastic properties. In some embodiments, the nozzle portion 104 includes a plurality of nozzles. In some embodiments, each nozzle is capable of depositing a different molten material, in some embodiments, two or more nozzles may deposit the same molten material.

In this exemplary embodiment, printing material 110 is fed through a feeder 112 and into a heating element 114 before being extruded from the nozzle portion 104. The printing material 110 can be any suitable 3D printing material that has thermoplastic properties. Typical 3D printing material includes ceramic materials, polymers (including thermoplastic, thermosets and nylon), metals, alloys, green sand and other inorganic materials of various formulations. The printing material 110 may be on a filament, such as, for example, a metal wire, for easier feeding into the 3D printing device. In some embodiments, where a different 3D printing method is used, for example SLS, the printing material may be in the form of one or more compositions of material powders.

The exemplary 3D printing device 100 may be moved in three dimensions by linear motors, a mechanical arm or the like (not shown). Movement of the device may be controlled or guided by a processor and movement may be based on G-code (path information), which is generated by slicing a three-dimensional drawing file, for example an STL (STereoLithography) file. The feeder 112 and nozzle portion 104 may also be controlled by the processor such that flow of the printing material 110 from the nozzle portion 104 may be increased, decreased or turned off. The processor may also control the temperature of the output material by adjusting the heating element 114. If the device 100 includes more than one type of printing material 110, the processor may also control which materials and in what proportion are deposited at any given time.

The exemplary 3D printing device 100 also includes a plasma applicator 102. The plasma applicator 102 creates a plasma 120 on the surface of the deposited material 108. The plasma applicator 102 may be any type of direct or indirect plasma applicator, such as a plasma jet, dielectric barrier discharge (DBD), DBD plasma jet, gliding arc, corona discharge, arc discharge, pulsed spark discharge, hollow cathode discharge, or glow discharge. The plasma 120 may emit light in the UV A, B, C, visible and near-infrared part of the electromagnetic spectrum in a continuous or pulsed mode. A processor, including the one described above, may control the temperature of the plasma, the temperature of the gas feed (in embodiments that utilize a plasma jet, or have gas flow), the plasma power, frequency and other adjustable parameters, time on/off of the plasma, and the like.

In some embodiments, the plasma applicators described herein are non-thermal plasma applicators and the plasma generated has a temperature that is about room temperature. In some embodiments, the plasma applicators described herein generate plasmas at higher temperatures than room temperature. In some embodiments, the plasma applicators described herein generate plasmas at a temperature that is at or about the same temperature as the glass transition point of the printing materials. In some embodiments, the plasma applicators described herein generate plasmas at a temperature that is at or about the same temperature as the melting point of the printing materials. In some embodiments the temperature of the generated plasma is directly related to the glass transition point of the printed material. In some embodiments, the temperature of the generated plasma is slightly above the glass transition point of the printed material. In some embodiments, the temperature of the generated plasma is slightly below the glass transition point of the printed material. In some embodiments, the temperature of the plasma is selected so that gas flowing through the plasma contacts the printed material at a temperature that is near the glass transition point of the printed material. In some embodiments, the temperature of the plasma is selected so that gas flowing through the plasma contacts a first layer of printed material prior to a second layer of printed material being deposited on the first layer. In some embodiments, the temperature of the plasma generated is less than about 250° Celsius. In some embodiments, the temperature of the plasma generated is less than about 240° Celsius. In some embodiments, the temperature of the plasma generated is less than about 230° Celsius. In some embodiments, the temperature of the plasma generated is less than about 220° Celsius. In some embodiments, the temperature of the plasma generated is less than about 210° Celsius. In some embodiments, the temperature of the plasma generated is less than about 200° Celsius. In some embodiments, the temperature of the plasma generated is less than about 190° Celsius. Accordingly, for the applications and apparatuses described herein, a wide range of plasma temperatures may be used depending on the particular situation.

In some embodiments, when a gas flow is used, the gas is heated to a desired temperature. In some embodiments, the gas has a temperature that is about room temperature. In some embodiments, the gas is heated to a higher temperature than room temperature. In some embodiments, the gas is at a temperature that is at or about the same temperature as the glass transition point of the printing materials. In some embodiments, the gas is at a temperature that is at or about the same temperature as the melting point of the printing materials. In some embodiments the temperature of the gas is directly related to the glass transition point of the printed material. In some embodiments, the temperature of the gas is slightly above the glass transition point of the printed material. In some embodiments, the temperature of the gas is slightly below the glass transition point of the printed material. In some embodiments, the temperature of the gas is selected so that gas contacts the printed material at a temperature that is near the glass transition point of the printed material. In some embodiments, the temperature of the gas is selected so that gas contacts a first layer of printed material prior to a second layer of printed material being deposited on the first layer. In some embodiments, the temperature of the gas is less than about 250° Celsius. In some embodiments, the temperature of the gas is less than about 240° Celsius. In some embodiments, the temperature of the gas is less than about 230° Celsius. In some embodiments, the temperature of the gas is less than about 220° Celsius. In some embodiments, the temperature of the gas is less than about 210° Celsius. In some embodiments, the temperature of the gas is less than about 200° Celsius. In some embodiments, the temperature of the gas is less than about 190° Celsius. Accordingly, for the applications and apparatuses described herein, a wide range of the gas temperatures may be used.

The plasma applicators described herein may be powered by a DC, pulsed DC, pulsed AC, AC sinusoidal, RF or microwave power supply. The voltage waveforms may be sine, damped sine, square, sawtooth or triangle. The power supply may be integrated with the plasma applicator 102, embedded or removable (such as, for example, a battery) or the plasma applicator may include a connector for connecting to an external power supply. The plasma applicator 102 may further include power circuitry for converting and/or conditioning the power from the power supply (e.g., stepping down voltage, removing ripple current, etc.).

In some embodiments the plasma applicator includes a gas inlet for connecting a gas source for plasma generation. The type of gas, gases or other additives used may be tailored and used to affect resulting properties of the final 3D printed object. Exemplary noble gases, such as helium or argon, or molecular gases, such as air, oxygen, nitrogen or any mixture thereof may be used. When gas is used and it flows onto the printed material or material that is receiving the printed material it is preferable that the temperature of the gas and/or plasma is near the glass transition point of the printed material, however, the temperature may be any of the ranges described above.

In some embodiments the plasma functionalizes and/or cross-links the surface to improve surface wettability, stability, reduce permeability, increase adhesion between similar materials, such as polymer-polymer, increase adhesion between dissimilar materials, polymer-ceramic, polymer-metal, carbon reinforced fibers-polymer, polymer implant-cells and the like. In some embodiments, air, oxygen gas, or noble gas, such as helium or argon, is used as the working gas in the ambient air conditions. In some embodiments, the plasma may promote surface oxidation and create hydroxyl groups (OH groups) on the surface to improve surface-layer adhesion. In some embodiments, oxidized material and hydroxyl groups, which are hydrophilic, can increase surface wettability. Furthermore, in some embodiments, the porosity of the 3D parts can be reduced. In some embodiments, improved interlayer adhesion can reduce/eliminate the gap between newly placed molten materials and the deposited material. In some embodiments, cross-linking agents, such as UV, catalyst or radicals, produced from the plasma cross-links or cures polymer surfaces (e.g., thermoset surface) may be used to improve the barrier properties of the material.

In some exemplary embodiments, a noble gas, such as helium or argon, is mixed with aerosolized or vaporized monomers that is passed through the plasma to provide a coating such as, for example, a waterproof coating, a wear or scratch resistant, UV light resistant , a biocompatible, or a strong adhesive coating. A waterproof coating can be achieved by, for example, creating plasma using a mixture of helium and carbon tetrafluoride (CF₄) monomers. Carbon tetrafluoride plasma can form hydrophobic coatings of fluorine-containing groups. An adhesion coating can be achieved through the attachment of polar groups (oxygen-based) through plasma functionalization of a deposited coating. In some embodiments, the coating may be used to make the final 3D printed object scratch-resistant (e.g., using acrylate monomers), biocompatible (e.g., using diethylene glycol dimethyl ether—Diglyme), and/or create an air and/or moisture barrier. In some embodiments, for example if a DBD plasma applicator is used, no gas supply is necessary and plasma can be generated in the ambient gases between the plasma applicator and the deposited material. In some exemplary embodiments, aerosolized or vaporized material, such as, for example, monomers, which may be, for example, acrylic acid, methyl methacrylate (MMA), lactic acid, acrylonitrile, butadiene, styrene, polyamic acid and the like are passed through the plasma and coatings are formed on a surface through plasma enhanced vapor deposition (PECVD) to increase adhesion, provide additional polymer chains, or improve other qualities of the printed object.

In some embodiments, the plasma applicator 102 is rotatably connected to the body of the 3D printing device 100 so that the plasma applicator 102 can rotate around the body (e.g., around the heating element 114) of the 3D printing device 100. Rotation of the plasma applicator 102 may be effectuated by one or more servo motors, pistons, gears, solenoids or the like and may be controlled by the processor controlling the 3D printing device 100. The processor may also control the power to the plasma applicator 102 and/or the gas flow through the plasma applicator 102. In some embodiments, the plasma at least partially surrounds the printing material. In some embodiments, the plasma substantially surrounds the printing material.

In FIGS. 1A and 1B, solidified (or solidifying) deposited material 108 is treated with plasma 120 immediately before a new layer of molten material 106 is deposited. In the embodiment of FIG. 1A, the plasma applicator 102 is positioned so that the plasma 120 is created in front of the nozzle portion 104 in the direction that the nozzle 104 of the 3D printing device 100 is traveling. For example, if the 3D printing device 100 is traveling to the right (relative to some viewing angle) then the plasma 120 will be to the right of nozzle portion 104. As illustrated in FIG. 1B, when the 3D printing device 100 changes direction, the plasma applicator 102 rotates around the body of the 3D printing device 100 so that it remains in front of the nozzle portion 104 in the direction of travel. In this way, the plasma applicator 102 always precedes the molten material 106 and is applied directly before the molten material 106 is applied to the deposited material 108. Because the plasma 120 is not a “high temperature” plasma and is designed to produce a plasma that is above the material's glass transition temperature but below the melting point of the printed material, it does not melt or otherwise warp the solidified (or solidifying) deposited material 108. Having the plasma applicator in front of the print head, can also be achieved by different embodiments, such as, for example, embodiments in which two or a plurality of plasma applicators are fixed stationary relative to the printer device and only the plasma applicator(s) in front of the printing nozzle in the direction of travel is turned on to treated the deposited material.

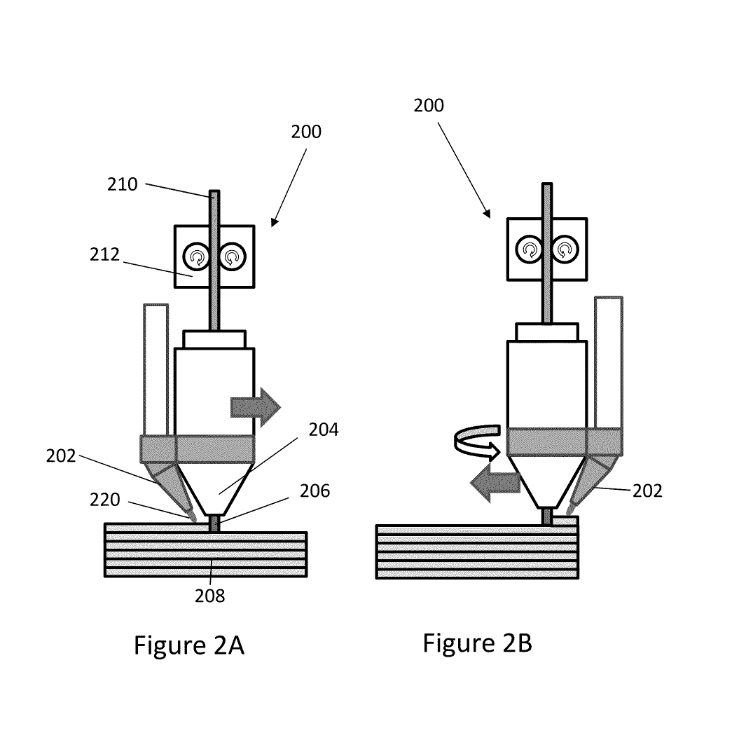

In another exemplary embodiment, depicted in FIGS. 2A and 2B, newly placed molten material 206 is treated with the plasma 220 after it is deposited. In this embodiment, as seen in FIG. 2A, the plasma applicator 202 is positioned so that the plasma 220 is generated behind the nozzle portion 204 relative to the direction that the 3D printing device 200 is traveling. For example, if the 3D printing device 200 is traveling to the right (relative to some viewing angle) then the plasma discharge 220 will be to the left of nozzle portion 204. As illustrated in FIG. 2B, when the 3D printing device 200 changes direction, the plasma applicator 202 rotates around the body of the 3D printing device 200 so that it remains on the side opposite to the direction of travel (i.e. the back side) relative to the nozzle portion 204. In this way, the plasma applicator 202 always follows the molten material 206 and is applied directly after the molten material 206 is applied to the deposited material 208. This can also be achieved by a number of different other embodiments, such as, for example, embodiments in which two or a plurality of plasma applicators are fixed stationary relative to the printer device and only the plasma applicator on the side opposite the direction of travel will be turned on to treat the newly placed molten material. The plasma applicator 202 may be any of the plasma applicators described herein, and may uses any of the working gases described herein.

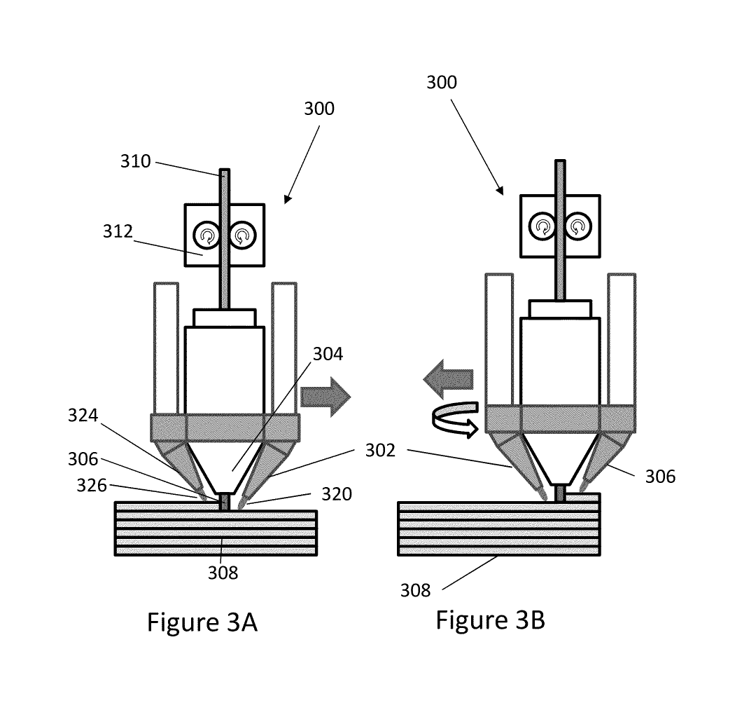

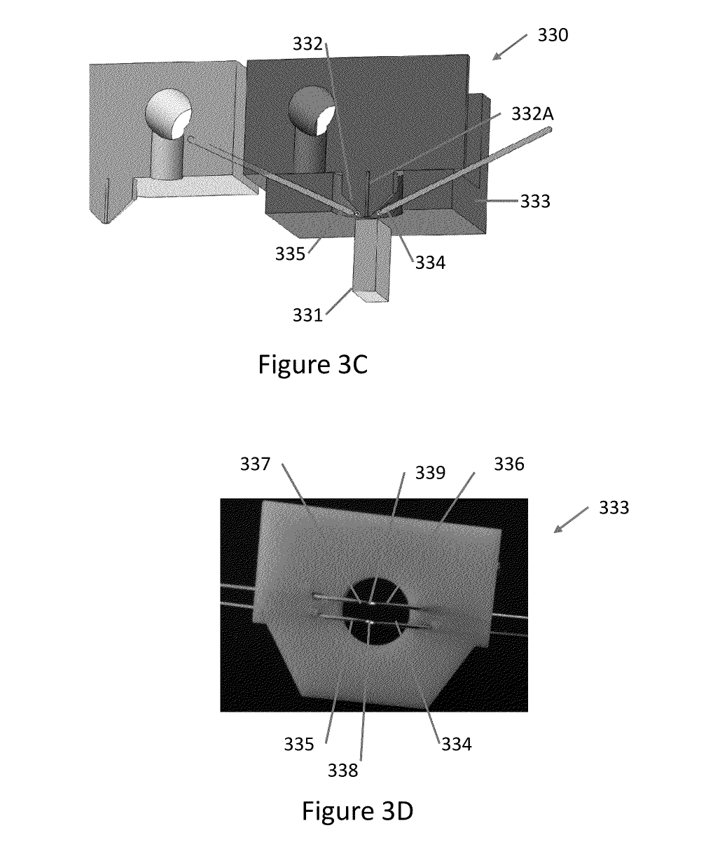

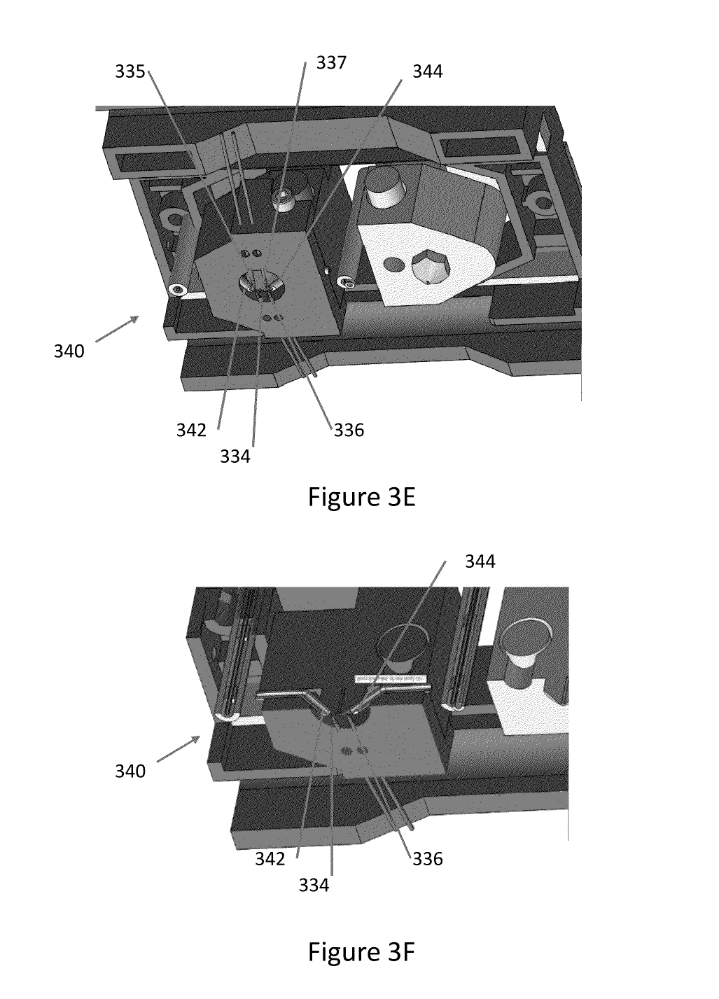

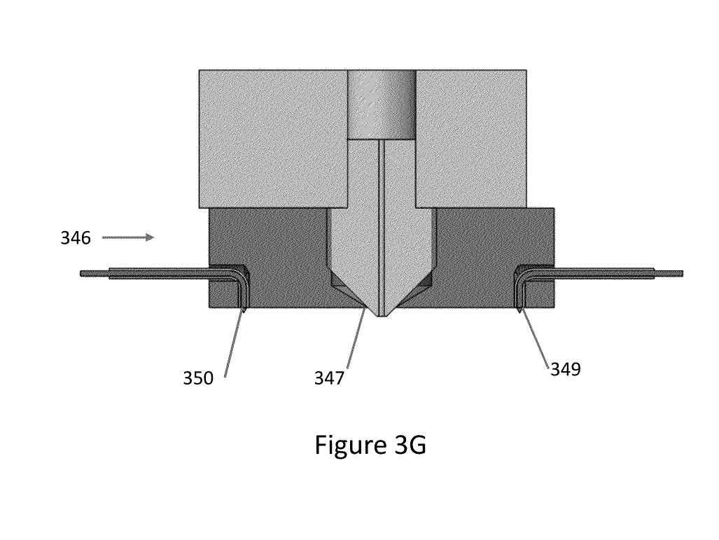

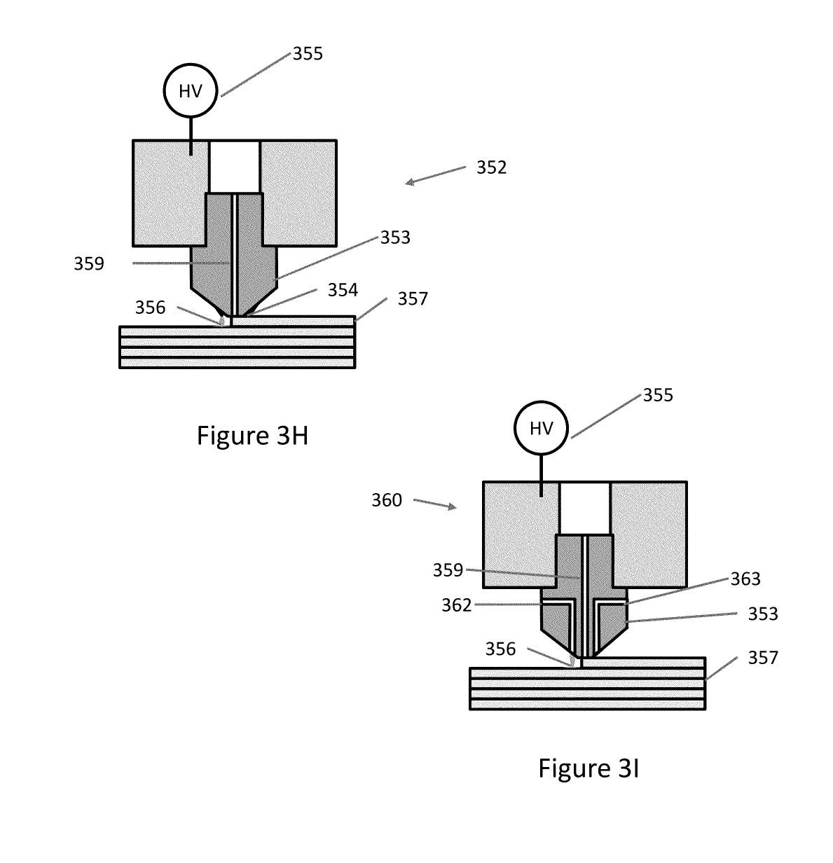

In another exemplary embodiment, depicted in FIGS. 3A and 3B, solidified (or solidifying) deposited material 308 is treated with plasma 320 immediately before a new layer of molten material 306 is deposited, and newly placed molten material 306 is also treated with plasma 326 after it is deposited by plasma applicator 302. Plasma applicator 302 may be any of the types of plasma applicators described above and may use any of the working gases, if any, identified above, including air. In this embodiment, as seen in FIG. 3A, the 3D printing device 300 also includes a second plasma applicator 324 positioned opposite the plasma applicator 302 with respect to the 3D printing device 300. The second plasma applicator 324 generates a second plasma 326 on the surface of the deposited material 308. The second plasma applicator 324 may be of any of the types described above and use any of the working gasses described above, if any, including air. In some embodiments the second plasma applicator 324 is the same as the plasma applicator 302. In some embodiments the second plasma applicator 324 is a different type of plasma applicator than the first plasma applicator 302 (e.g., one may be a plasma jet and one may be a DBD). In some embodiments the second plasma applicator 324 uses a different type of gas mixture to create a different effect than the plasma applicator 302. For example, the plasma applicator used to treat the newly placed molten material may produce plasma which emits specific wavelength and/or intensity which can efficiently cure or crosslink the newly placed molten material, while the plasma applicator for the deposited material may produce plasma containing abundant oxygen species and/or hydroxyl radicals to promote surface hydrophilicity (wettability).

As illustrated in FIG. 3A, the pair of plasma applicators 302 and 324 is positioned so that one is in the same direction and one is in the opposite direction, relative to the nozzle portion 304, that the 3D printing device 300 is traveling. For example, if the 3D printing device 300 is traveling to the left (relative to some viewing angle) then one plasma applicator will be to the left of nozzle portion 304 and the other plasma applicator will be to the right. As illustrated in FIG. 3B, when the 3D printing device 300 changes direction, the pair of plasma applicators 302 and 324 may rotate around the body of the 3D printing device 300 so that they remain in the same positions relative to the direction of travel of the nozzle portion 304. In this way, one plasma applicator always precedes the molten material 306 and the other always follows the molten material 306. In some embodiments in which the two plasma applicators are the same, the pair of plasma applicators may be fixed at stationary location but are able to adjust their heights to apply different treatments to the deposited materials and the newly placed molten material. This can also be achieved by a number of different embodiments, such as embodiments in which a single continuous 360 degree plasma applicator is an annulus shape where the printer head is at the center. In some embodiments, the plasma applicators generate plasma around about all of the strand of printed material, in some embodiments the plasma applicators generate plasma around substantially the entire of strand of printed material. As described above, the plasma applicators may be any type of plasma applicators, including those with gas flows and those without gas flows.

FIG. 3C is a partial cross-section of an exemplary 3D printer 330 that includes a 3D printer head 332 with an exemplary plasma applicator 333 secured thereto. FIG. 3D is a view looking up at the bottom of the exemplary plasma applicator 333 of FIG. 3C. The 3D printer head 332 extrudes a molten strand of printing material (not shown) to form a printed object 331. The strand of molten printed material passes through outlet passage 332A.

Plasma applicator 333 includes two pairs of electrodes, 334, 335 and 336, 337. In this exemplary embodiment, electrodes 334 and 336 are connected to one or more high voltage power sources, such as those described above and electrodes 335, 337 are connected to ground. Electrodes 334, 336 (and the electrodes in other exemplary embodiments described herein) may be connected directly to the high voltage source or connected with a circuit to limit or control the discharge current. Limiting or controlling the discharge current may be used to control the temperature of the plasma. In some embodiments, the plasma is a non-thermal plasma at room temperature, in some embodiments the plasma has a temperature near or above the glass transition point of the printed materials. The circuit to limit current may include one or more resistors, capacitors, inductors or the like. Electrodes 335, 337 (and the electrodes in other exemplary embodiments described herein) may be directly connected to the ground or connected to the ground through a resistor or other desired circuitry. Plasma 338, 339 is generated between the pairs of electrodes. Plasma applicator 333 is connected to print head 332 in a manor such that one or both of plasmas 338 and 339 contact the molten strand of printed material being deposited and the one contacts the printed device 331 directly before the molten strand is deposited onto the surface of the printed device 331. In some embodiments described herein, the print head is made of a non-conducive material and in some embodiments is coated with a dielectric material to reduce or eliminate arcing from the electrodes to the print head.

FIG. 3E is a view looking up at a portion of a bottom of an exemplary plasma applicator that may be also be used for vapor deposition coating and FIG. 3F is a partial cross-section of the exemplary plasma applicator of FIG. 3E. Plasma applicator 340 includes many of the same components as plasma applicator 333 and like components are not re-described in detail with respect to this exemplary embodiment. Plasma applicator 340 includes a first tube 342 to supply gas to the area between electrodes 334 and 335 for generation of plasma. In addition, plasma applicator 340 includes a second tube 344 to supply gas to the area between electrodes 336 and 337 for generation of plasma. The gas supplied through tubes 342, 344 may be any of the gasses described above and may be at any temperature, such as, for example, the temperatures described herein. In some embodiments, during operation, as molten printing material is extruded out of the print head, the molten printed material is treated with plasma, In some embodiments, the surface where the molten printed material is being treated with plasma. In some embodiments, both are being treated with plasma. As described above, the plasmas may be different plasmas, use different gasses, may be the same plasmas, and/or may use the same working gas.

In addition, plasma applicator 340 may be used for vapor deposition coatings. In some embodiments, when being used for vapor deposition coatings, the print head 332 is not used to deposit molten material. In some exemplary embodiments, aerosolized or vaporized material, such as, for example, monomers such as, for example, acrylic acid, methyl methacrylate (MMA), lactic acid, acrylonitrile, butadiene, styrene, polyamic acid and the like are fed through one or both of gas tubes 342, 344. The vaporized material passes through one or more of the gas tubes 342, 344, through the plasma generated by one or more pairs of electrodes 334, 335, 336, 337, and is deposited on the surface. In some embodiments, the print head 332 is depositing molten printed material during the process. In such embodiments, the plasma applicator 340 may be depositing a very thin coating to the strand of molten material with plasma generated by one set of electrodes, such as, for example 334, 335 and is using the second set of electrodes, such as, for example 336, 337 and their associated gas tube, 344 through vapor deposition. In some embodiments, as the print head 332 moves along the surface that the molten strand of printing material is going to be printed on, a vapor deposition coating is deposited on the surface just before the printing material is deposited on the surface. In some embodiments, the strand of molten printing material is treated with plasma from one set of electrodes and also receives a vapor deposition coating from the other set of electrodes and corresponding gas tube. In some embodiments, the strand of molten printing material is treated with plasma from the first set of electrodes prior to being printed and receives a vapor deposition coating immediately after printing from the second set of electrodes and associated tube.

FIG. 3G is a partial cross-section of another exemplary 3D printer head and plasma applicator 346. Plasma applicator 346 surrounds print head 347 which extrudes molten printing material. Two or more electrodes 349, 350 at least partially surround print head 347. The two or more electrodes 349, 350 are connected to a high voltage source as described above and are configured to generate plasma between the electrodes and the surface of the substrate being printed. The surface of the print bed, and/or substrate being printed operates as a second electrode, and may be grounded or at a floating potential. During operation, the two or more electrodes 349, 350 may treat, one or more of the strand of molten printing material being extruded prior to the strand of molten printing material being deposited on a surface, the surface prior to the strand of molten printing material being deposited onto it, and/or one or more surfaces of the strand of molten printing material after it is deposited on the surface.

FIG. 3H is a partial cross-section of an exemplary 3D printer head and plasma applicator 352. Printer head 353 is made of a conductive material and is electrically coupled to a high voltage source 355. High voltage source 355 may be any of the high voltage sources described herein. Printer head 353 includes one or more sharp tips 354 at the end of the extrusion passage 359. When energized as described above, plasma 356 is generated between the one or more sharp tips 354 and the printed object 357. The one or more sharp tips 354 may be arranged so that plasma is generated between the one or more tips 354 and a surface of the printed object, and/or one or more surfaces of the strand of molten printed material.

FIG. 3I is a partial cross-section of an exemplary 3D printer head and plasma applicator 360 that may be used for plasma enhanced chemical vapor deposition (PECVD). 3D printer head and plasma applicator 360 is similar to 3D printer head and plasma applicator 352 and like components are not redescribed herein. 3D printer head and plasma applicator 360 includes gas feed channels 362, 363. Gas feed channels 362, 363 may be used to supply a working gas, and/or may be used for vapor deposition as described herein.

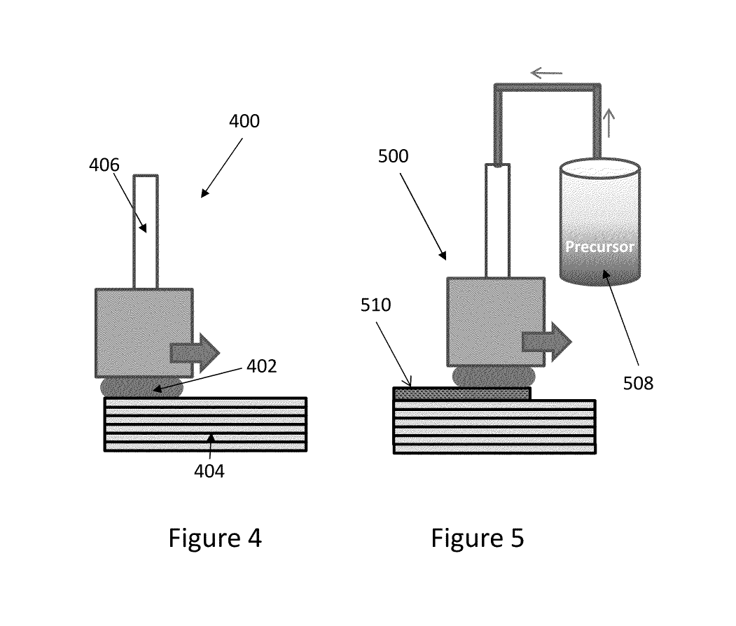

FIG. 4 illustrates an exemplary separate plasma applicator 400 for use in conjunction with a 3D printing device, for example 3D printing device 100 previously described. The exemplary plasma applicator 400 generates plasma 402 that contacts the solidified (or solidifying) deposited material 404. The exemplary plasma applicator 400 includes an electrical connection/gas inlet 406 for supplying plasma electricity and one or more gases as described above. The plasma applicator 400 may have any suitable power source as described above.

The plasma applicator 400 may include or be connected to one or mechanical arms and/or motors for two or three-dimensional movement relative to the surface on which the material is deposited. In some embodiments movement of the plasma applicator 400 and control of the plasma discharge 402 are controlled by the same processor controlling the 3D printing device. In some embodiments the plasma applicator 400 is controlled by a separate controller. In some embodiments movement of the plasma applicator 400 may be controlled manually.

Plasma 402 contacts the solidified (or solidifying) deposited material 404 between applications of molten material. Thus, plasma 402 is applied between each (or some) layers of the 3D printed object. In some embodiments the plasma 402 is swept over and/or around the deposited material 404. The plasma applications functionalize the topmost layer and increase its adhesion properties prior to applying the next layer of molten material. Plasma applicator 400 may be used in any of the embodiments disclosed herein.

In one embodiment, illustrated in FIG. 5, the plasma applicator 500 is used after completion of a 3D printed object. Plasma applicator 500 includes a supply of precursor material 508 that mixes with gas (or ambient air) during plasma generation to form a coating 510 on one or more surfaces of the 3D printed object. In some embodiments, the precursor material 508 is held in an external tank and pumped into the plasma applicator 500. In some embodiments the plasma applicator 500 includes a bubbler, nebulizer or spray nozzle for creating a vapor or aerosol spray during plasma generation.

In some embodiments the precursor material 508 is held in a container on and/or within plasma applicator 500. If the precursor material 508 includes, for example, monomers, the coating 510 may help make the 3D printed object scratch-resistant and/or water repellant and/or biocompatible and/or create an air/moisture barrier.

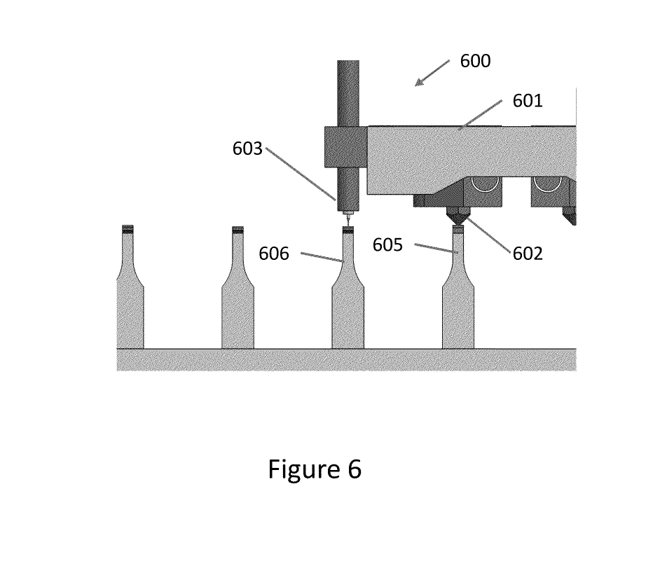

FIG. 6 is a schematic diagram of another exemplary embodiment of a 3D printing apparatus with plasma applicator for applying plasma and for providing a plasma enhanced chemical vapor deposition coating prior to adding a second layer of printed material or after a new layer of material has been printed. In this exemplary embodiment, a 3D printer and plasma applicator 600 are shown. In this exemplary embodiment, a print arm 601 includes a print head 602 and a plasma applicator 603. As the print head 602 is depositing a printed layer on a first part 605, a plasma applicator is treating a printed layer on a second part 606. In some embodiments, the print head will print a layer on part 606 and move to print the same layer on part 605. As print head 602 is printing the layer on part 605, the same layer on part 606 is being treated with plasma.

Examples Demonstrating an Increase In Bond Strength and Adhesion

The following examples are given solely for the purpose of illustration and are not to be construed as limiting on the present disclosure

In the following examples, various treatments were applied and enhanced adhesion was measured. A commercially available statistical analysis software, JMP, was used to analyze the results. The significance level (a) was chosen to be 0.05, which was used to conclude the significant difference between the control and the plasma-treated samples.

In the first experiment, air corona discharges were generated by applying an AC sine-wave high voltage to a needle electrode (the power consumption was about 16 W). The air corona discharges were used to treat ⅛″ thick ABS (acrylonitrile butadiene styrene) sheets immediately before an ABS filament was extruded using the FDM (fused deposition modeling) process to the ABS sheets. Control specimens were also prepared by applying the ABS filament to ABS sheets without any plasma treatment.

A force gauge was connected to a scrapper that was used to push the filaments off the surface of the plasma-treated and the control specimens. The maximum force applied to the filament to cause breakage was recorded and used to represent the filament bonding strength.

Multiple samples were prepared and JMP was used to analyze the results. The average force to breakage in the plasma-treated samples was about four (4) times greater than that in the control samples. Thus, the test results demonstrated that plasma treatment prior to extrusion increases bond strength.

In a second experiment, air corona discharges were generated by applying an AC sine-wave high voltage to a needle electrode (the power consumption was about 16 W). The air corona discharges were used to treat ⅛″-thick ABS (acrylonitrile butadiene styrene) sheets 10 times across the surface, and then an ABS filament was extruded using the FDM process to the plasma-treated site of the ABS sheets (2-step process). Control specimens were also prepared by applying the ABS filament to ABS sheets without any plasma treatment.

A force gauge was connected to a scrapper that was used to push the filaments off the surface of the plasma-treated and the control specimens. The maximum force applied to the filament to cause breakage was recorded and used to represent the filament bonding strength.

The average force to breakage in the plasma-treated samples was about three (3) times greater than that in the control samples. The results demonstrate that a surface subject to plasma treatment has improved bond strength.

In a third experiment, a two-step process with PECVD (Plasma-Enhanced Chemical Vapor Deposition) and plasma treatment was utilized. Four types of specimens were prepared in this experiment.

Specimen 1 (PMMA). A cold plasma jet was generated by feeding a mixture of helium gas and MMA (methyl methacrylate) vapor through a dielectric barrier discharge (DBD) based reactor. The flow rate of the helium was 2900 sccm (standard cubic centimeters per minute) and that of the helium for carrying the MMA vapor was 100 sccm, respectively. An AC sine-wave high voltage was used to drive the plasma jet. The plasma jet was used to provide a PMMA-like coating to the surface of either ⅛″-thick ABS sheets or ⅛″-thick PLA (polylactic acid) sheets, and then an ABS or PLA filament was extruded using the FDM process to the surface with the plasma coating.

Specimen 2 (PMMA+Plasma). The cold plasma jet was used to provide a PMMA-like coating to the surface of either ABS sheets or PLA (polylactic acid) sheets, and then the air corona discharges, as mentioned in the first experiment, were used to treat the ABS or PLA sheets immediately before an ABS or PLA filament was extruded to the sheets.

Specimen 3 (Plasma). No coating was applied to either the ABS or the PLA sheets. The specimen was prepared by applying the air corona discharges to ABS or PLA sheets immediately before an ABS or PLA filament was extruded to the sheets.

Specimen 4 (Control). Control specimens were also prepared by solely applying the ABS or PLA filament to ABS sheets or PLA sheets without any plasma treatment.

A force gauge was connected to a scrapper that was used to push the filaments off the surface of the plasma-treated and the control specimens. The maximum force applied to the filament to cause breakage was recorded and used to represent the filament bonding strength.

Multiple samples were prepared and JMP was used to analyze the results. The average force to breakage in each of the plasma-treated samples (PMMA, PMMA+Plasma, and Plasma alone) was about three (3) times greater than that in the control samples. The results demonstrated that a coating between layers can improve interlayered bond strength.

While the present invention has been illustrated by the description of embodiments thereof and while the embodiments have been described in considerable detail, it is not the intention of the applicant to restrict or in any way limit the scope of the appended claims to such detail. The plasma types, gasses, temperatures and the like described herein with respect to one or more embodiments may be used in the other exemplary embodiments, or variations therein. In addition, components on some embodiments may be used in combination with other embodiments in whole or in part. Further, additional advantages and modifications will readily appear to those skilled in the art. Therefore, the invention, in its broader aspects, is not limited to the specific details, the representative apparatus and illustrative examples shown and described. Accordingly, departures may be made from such details without departing from the spirit or scope of the applicant's general inventive concept.

1. A system for printing three-dimensional objects comprising:
a 3D printing device;
the 3D printing device having one or more nozzles for depositing a printed material; and
a plasma applicator;
wherein the plasma applicator generates plasma proximate the surface of the printed material.

2. The system of claim 1 wherein the plasma contacts the printed material prior to depositing a second layer of the printed material.

3. The system of claim 1 wherein the plasma contacts the printed material as it is being deposited.

4. The system of claim 1 wherein the plasma contacts the printed material after the printed material is deposited.

5. The system of claim 1 wherein the plasma applicator generates plasma at a temperature that is above room temperature and below the melting point of the printed material.

6. The system of claim 1 wherein the plasma applicator comprises a gas feed tube and the gas is heated to a temperature that is above room temperature and below the melting point of the printed material.

7. The system of claim 1 comprising at least two plasma applicators and wherein at least one plasma applicator is located upstream of the printing head and at least one plasma applicator is located downstream of the printing head.

8. The system of claim 1 wherein the plasma applicator is positioned relative to the 3D printing device to apply plasma to a solidified layer of 3D printing material before application of a molten layer of 3D printing material.

9. The system of claim 1 wherein the plasma applicator is positioned relative to the 3D printing device to apply plasma to a molten layer of 3D printing material after the material is deposited.

10. The system of claim 1 further comprising a second plasma applicator, wherein the first plasma applicator is positioned relative to the 3D printing device to apply plasma to a layer of 3D printing material before application of a molten layer of 3D printing material and the second plasma applicator is positioned relative to the 3D printing device to apply plasma to a molten layer of 3D printing material after the material is deposited.

11. The system of claim 1 wherein the plasma applicator is a dielectric barrier discharge plasma applicator.

12. The system of claim 1 wherein the plasma applicator is a plasma jet plasma applicator.

13. The system of claim 1 wherein the plasma applicator is a corona discharge plasma applicator.

14. The system of claim 6 wherein the gas is mixed with a monomer.

15. A method of printing a three-dimensional object comprising a plurality of layers of 3D printing material, the method comprising:
providing a 3D printer;
providing a plasma applicator secured to the 3D printer;
energizing the 3D printer to deposit a layer of 3D printing material;
energizing the plasma applicator to applying plasma to the deposited layer of 3D printing material; and
depositing a second layer of 3D printing material.

16. The method of claim 15 wherein the plasma is applied prior to the layer of 3D printing to increase interlayer adhesion.

17. The method of claim 15 wherein the plasma is applied after an entire layer of 3D printing material is deposited to reduce porosity.

18. A 3D printing device comprising:
a print head for depositing a material having thermoplastic properties;
a plasma applicator for treating the material having thermoplastic properties; and
a high voltage power source for powering the plasma applicator.

19. The 3D printing device of claim 18 wherein the plasma applicator generates a plasma having a temperature that is a function of the glass transition point of the material having thermoplastic properties.

20. The 3D printing device of claim 18 wherein the plasma applicator uses a working gas and the temperature of the gas contacting the surface of a deposited material is above room temperature and below the melting point of the deposited material.
